(19) United States
(12) Patent Application Publication
(10) Pub. No.: US 2021/0112009 A1
(43) Pub. Date: Apr. 15, 2021

(54) NETWORK MANAGEMENT APPARATUS AND METHOD

(71) Applicant: HITACHI, LTD., Tokyo (JP)

(72) Inventors: Souichi TAKASHIGE, Tokyo (JP); Masakuni AGETSUMA, Tokyo (JP); Hideo SAITO, Tokyo (JP)

(73) Assignee: Hitachi, Ltd.

(21) Appl. No.: 16/824,445

(22) Filed: Mar. 19, 2020

(30) Foreign Application Priority Data
Oct. 10, 2019 (JP) 2019-187186

(51) Int. Cl. H04L 12/803; H04L 12/823; H04L 12/24; H04L 12/721; H04L 12/26

(52) U.S. Cl. CPC H04L 47/125; H04L 47/32; H04L 41/0213; H04L 43/0817; H04L 41/12; H04L 45/123; H04L 41/046

(57) ABSTRACT

A network management method includes: collecting information on performance and a configuration of a network from a network device and respective nodes that constitute the network; estimating, based on the collected information, a path in the network for each communication executed between the nodes via the network; determining, based on an estimated result of the path of each communication, whether deviation exists in the paths used for communications in the network, and determining whether an overload occurs in the network; and determining, based on a determination result of whether the deviation exists in the paths and a determination result of whether the overload occurs, control content for the corresponding node, and controlling the node in accordance with a determined result.

### BACKGROUND OF THE INVENTION

### 1. Field of the Invention

The present invention relates to a network management apparatus and a method, and is preferably applied, for example, to a network management apparatus that manages a network band in a distributed storage cluster.

### 2. Description of the Related Art

A software defined storage (SDS) technology is a technology in which a storage function is operated as software on a general-purpose computer, and processing performance and a capacity can be easily scaled out by adding the computer (hereinafter, referred to as an SDS node). In a storage system to which such an SDS is applied, it is necessary to manage network performance of an entire cluster so that use efficiency of the network is not decreased due to the addition of the SDS node.

As a network of a recent data center such as the SDS, it is common to configure an architecture called a Leaf-Spine network or a Fat-Tree network that constructs Fabric of a network by using an inexpensive and popular Ethernet instead of a high-speed internal bus such as a peripheral component interconnect (PCI), and a reliable network such as a Fibre channel (FC) or an Infiniaband.

In these network architectures, in order to secure a network band, connections among switches are multiplexed, and load distribution is executed on a plurality of paths to improve a total network band. In the load distribution, it is common to configure a network in which a protocol such as an equal cost multi path (ECMP) or a link aggregation control protocol (LACP) is used in a load distribution algorithm of a network switch.

In the protocol such as the ECMP or the LACP, a stateless processing is executed to speed up a load distribution processing. In addition, in order to avoid complication of a processing due to overtaking of order and the like in a transmission control protocol (TCP), a communication path is determined by a hash function in which a transmission source, an internet protocol (IP) address of a transmission destination, and a transmission or reception port number, which are provided in a header of a transmission control protocol/user datagram protocol (TCP/UDP), are used as input values.

For installation, a protocol based on exclusive OR (XOR), a cyclic redundancy check (CRC), or the like is often used. However, in any case, a hash value may deviate because static information is used as abase, and traffic may deviate to a specific communication path (hereinafter, referred to as path deviation). When such path deviation occurs, use efficiency of the entire network decreases. As a result, communication performance of the network such as throughput and latency decreases.

In a Multipath-TCP (MP-TCP), a socket for communicating with an application and a socket for actually transferring data can be separated, and data can be divided into a plurality of sockets so as to be transferred in parallel. In effect, for the same set of SDS nodes, when the number of TCP connections is increased and a chance of load distribution is increased, a probability of deviation in a hash value can be reduced, and the use efficiency of the network can be indirectly improved.

As compared with band control on a network device side, since such a configuration of a band limitation on an SDS node side is general-purpose and applicable to any type of device, there is a need for an SDS used in a wide range of environments.

In a method of multiplexing a TCP communication such as the MP-TCP, in view of a configuration and a load of the network, it is important to determine how much traffic is to be multiplexed on which communication path, as tuning for improving performance.

WO 2016/069433 discloses an invention in which proxy servers that manage path information are provided on both ends of a network including a plurality of communication paths such as Leaf Spine, and a plurality of paths (communication paths) used by these proxy servers for MP-TCP are managed. According to the invention disclosed in WO 2016/069433, when an application and a host that executes communication execute a TCP communication, load distribution is automatically executed on a plurality of communication paths that exist on the network.

However, according to the invention disclosed in WO 2016/069433, throughput may be deteriorated when the entire network is in an overload state, and TCP-Incast due to buffer overrun of a network device may occur when a load of a communication source (transmission source of a packet) of the network is larger than a load of a communication destination (transmission destination of a packet).

In the invention disclosed in WO 2016/069433, although only information of two SDS nodes, a communication source and a communication destination, as well as information of an intermediate path therebetween are handled, SDS nodes cannot be actually controlled (for example, increase or decrease the number of TCP connections or limit a band) with reference to information on another network communication that passes through the intermediate path.

Further, in the invention disclosed in WO 2016/069433, even when a state of a load on an SDS node side is referred, it cannot be determined whether a state of an own SDS node can maintain appropriate throughput unless being compared with a state of communication of another SDS node. Therefore, there is a need for a method in which network performance can be collectively managed, and a decrease in the network performance can be prevented while improving use efficiency of the entire network.

### SUMMARY OF THE INVENTION

The present invention has been made in view of the above circumstances, and intends to propose a network management apparatus and method in which network performance can be collectively managed, and a decrease in the network performance can be prevented while improving use efficiency of an entire network.

In order to solve the above problems, the invention provides a network management apparatus configured to manage a network configured to connect nodes in a distributed storage system including a plurality of nodes, and the network management apparatus includes: a network information collection unit configured to collect information on performance and a configuration of the network from a network device and the respective nodes that constitute the network; a path estimation unit configured to estimate, based on the information collected by the network information collection unit, a path in the network for each communication executed between the nodes via the network; a path deviation occurrence determination unit configured to determine, based on an estimated result of the path of each communication, whether deviation exists in the paths used for communications in the network; an overload determination unit configured to determine, based on the estimated result of the path of each communication, whether an overload occurs in the network; and a control unit configured to determine, based on a determination result of the path deviation occurrence determination unit and a determination result of the overload determination unit, control content for a corresponding node, and to control the node in accordance with a determined result.

An aspect of the invention provides a network management method to be executed by a network management apparatus that manages a network that connects nodes in a distributed storage system including a plurality of nodes, and the network management method includes: a first step of collecting information on performance and a configuration of the network from a network device and the respective nodes that constitute the network; a second step of estimating, based on the collected information, a path in the network for each communication executed between the nodes via the network; a third step of determining, based on an estimated result of the path of each communication, whether deviation exists in the paths used for communications in the network, and determining whether an overload occurs in the network; and a fourth step of determining, based on a determination result of whether the deviation exists in the paths and a determination result of whether the overload occurs, control content for the corresponding node, and of controlling the node in accordance with a determined result.

According to the network management apparatus and method of the present invention, the respective nodes can be appropriately controlled in accordance with the situation of the entire network.

According to the present invention, it is possible to implement a network management apparatus and method in which network performance can be collectively managed, and a decrease in the network performance can be prevented while improving use efficiency of an entire network.

### BRIEF DESCRIPTION OF THE DRAWINGS

FIG. 1 is a block diagram showing an overall configuration of a storage system according to the present embodiment.

FIG. 2 is a block diagram showing a logical configuration of a network management server.

FIG. 3 is a table showing a configuration of anode-side network performance information table.

FIG. 4 is a table showing a configuration of a network-side network performance information table.

FIG. 5 is a table showing a configuration of a port connection information table.

FIG. 6 is a table showing a configuration of an interface-address correspondence information table.

FIG. 7 is a table showing a configuration of a routing information table.

FIG. 8 is a table showing a configuration of a TCP communication path candidate information table.

FIG. 9 is a diagram illustrating sections in an in-cluster network.

FIG. 10 is a table showing a configuration of an in-cluster communication control history information table.

FIG. 11 is a flowchart showing a processing procedure of a network information acquisition processing.

FIG. 12 is a flowchart showing a processing procedure of a network management processing.

FIG. 13A is a block diagram illustrating control content of an in-cluster communication control unit.

FIG. 13B is a block diagram illustrating control content of the in-cluster communication control unit.

FIG. 13C is a block diagram illustrating control content of the in-cluster communication control unit.

FIG. 13D is a block diagram illustrating control content of the in-cluster communication control unit.

FIG. 13E is a block diagram illustrating control content of the in-cluster communication control unit.

FIG. 14 is a flowchart showing a processing procedure of a TCP communication path candidate detection processing.

FIG. 15 is a flowchart showing a processing procedure of a maximum likelihood path detection processing.

FIG. 16 is a flowchart showing a processing procedure of a path deviation occurrence determination processing.

FIG. 17 is a flowchart showing a processing procedure of an overload determination processing.

FIG. 18A is a flowchart showing a processing procedure of a control content determination processing.

FIG. 18B is a flowchart showing the processing procedure of the control content determination processing.

FIG. 18C is a flowchart showing the processing procedure of the control content determination processing.

### DESCRIPTION OF THE PREFERRED EMBODIMENTS

Hereinafter, an embodiment of the present invention will be described in detail with reference to the drawings.

### (1) Configuration of Storage System According to Present Embodiment

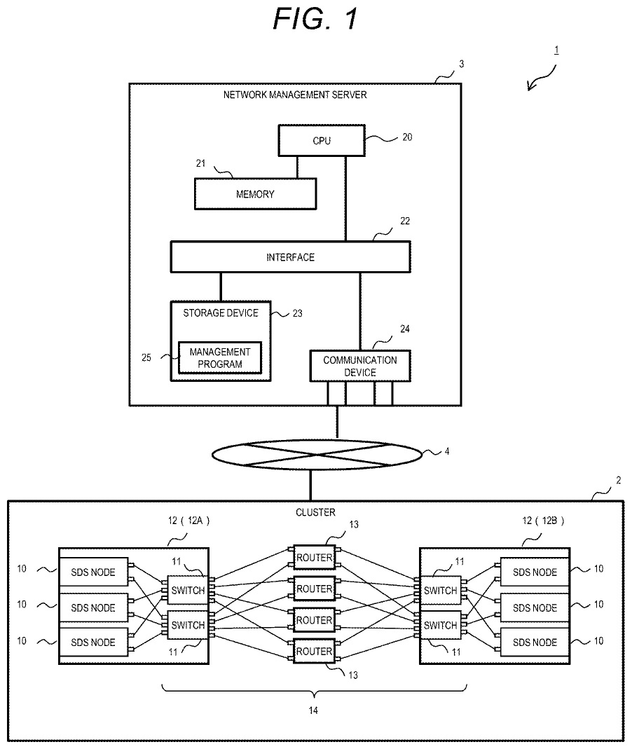

In FIG. 1, 1 indicates an entire storage system according to the present embodiment. The storage system 1 includes a cluster 2 that is a distributed storage system, and a network management server 3 that manages a network in the cluster 2. The cluster 2 and the network management server 3 are connected to each other via a network 4.

The cluster 2 includes one or a plurality of active-side SDS racks 12A, one or a plurality of standby-side SDS racks 12B provided respectively corresponding to these SDS racks 12A, and a plurality of routers 13. In the following, when there is no need to separately describe the active-side SDS racks 12A and the standby-side SDS racks 12B, these SDS racks 12A and 12B are collectively referred to as SDS racks 12.

One or a plurality of SDS nodes 10 and a plurality of switches 11 are respectively mounted on each of the SDS racks 12. These SDS nodes 10 are respectively connected to each of the switches 11 via communication paths, and the switches 11 are respectively connected to each of all the routers 13. Accordingly, a TCP/IP communication network 14 in the cluster 2 (hereinafter, referred to as an in-cluster network) is constructed by the switches 11 in the active-side SDS racks 12A, the routers 13, and the switches 11 in the standby-side SDS racks 12B.

In the cluster 2, data written to the SDS node 10 of the active-side SDS rack 12A from a host device (not shown) is transferred, via the in-cluster network 14, to the SDS node 10 in the standby-side SDS rack 12B and backed up therein synchronously or asynchronously with the writing to the SDS node 10. Accordingly, when a failure occurs in the SDS node 10 in the active-side SDS rack 12A, operation of the cluster 2 can be continued by switching the SDS node 10 in the standby-side SDS rack 12B to the active side.

The network management server 3 is a general-purpose server apparatus including a central processing unit (CPU) 20, a memory 21, an interface 22, a storage device 23, and a communication device 24. The CPU 20 is a processor that controls operation of the entire network management server 3, and is connected to the memory 21 and the interface 22. Further, the memory 21 is, for example, a volatile semiconductor memory, and is used as a work memory of the CPU 20.

The storage device 23 is, for example, a large-capacity nonvolatile storage device such as a hard disk device, a solid state drive (SSD), and/or a flash memory, and is used for storing various programs and necessary data for a long period of time. A management program 25, which will be described below, is also stored and managed in the storage device 23, and is loaded into the memory 21 and executed by the CPU 20 when the network management server 3 is started.

The communication device 24 includes, for example, an Ethernet network card, and performs protocol control when the network management server 3 communicates with the SDS nodes 10, the switches 11, and the routers 13 in the cluster 2 via the network 4.

### (2) Network Management Function

Next, a network management function installed in the network management server 3 will be described. The network management function is a function of collecting information on performance and a configuration of the in-cluster network 14 respectively from network devices such as the SDS nodes 10, the switches 11, and the routers 13 in the cluster 2 (hereinafter, the switches 11 and the routers 13 are collectively referred to as network switches as appropriate), and of collectively managing, based on these pieces of collected information, the number of TCP connections and bands of TCP communications executed via the in-cluster network 14.

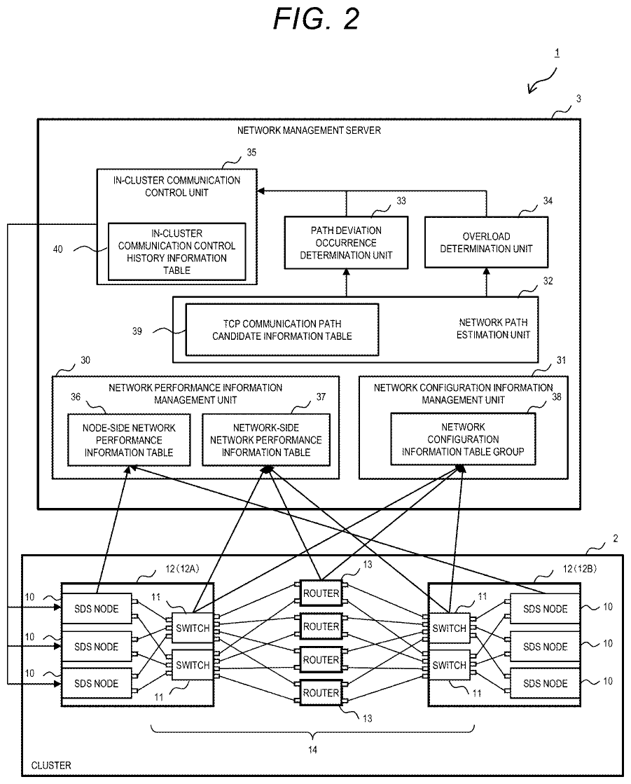

As units for implementing such a network management function, the network management server 3 is provided with a network performance information management unit 30, a network configuration information management unit 31, a network path estimation unit 32, a path deviation occurrence determination unit 33, an overload determination unit 34, and an in-cluster communication control unit 35, as shown in FIG. 2. These functional units are implemented by the CPU 20, which is described above with reference to FIG. 1, executing the management program 25 loaded from the storage device 23 to the memory 21.

As tables that store information for implementing the network management function, a node-side network performance information table 36, a network-side network performance information table 37, a network configuration information table group 38, a TCP communication path candidate information table 39, and an in-cluster communication control history information table 40 are stored in the storage device 23 of the network management server 3.

The network performance information management unit 30 is a functional unit having a function of collecting and managing information on the performance of the in-cluster network 14.

In practice, the network performance information management unit 30 periodically collects, respectively from the SDS nodes 10, performance information of the in-cluster network 14 regarding the TCP communications executed via the in-cluster network 14 between the SDS nodes 10 in the active-side SDS racks 12A and the SDS nodes 10 in the standby-side SDS racks 12B, and stores and manages these pieces of collected performance information in the node-side network performance information table 36. As units for the above processing, agents (not shown) that can obtain necessary information from an operating system (OS) are respectively mounted on the SDS nodes 10, and the network performance information management unit 30 collects the performance information from these agents.

The network performance information management unit 30 collects respectively from the network switches by using, for example, a simple network management protocol (SNMP), information such as throughput and the number of discarded packets at ports of the network switches (the switches 11 and the routers 13), and stores and manages these pieces of collected information in the network-side network performance information table 37.

The network configuration information management unit 31 is a functional unit having a function of periodically collecting information on the configuration of the in-cluster network 14 from the network switches in the cluster 2.

In practice, the network configuration information management unit 31 collects, respectively from the network switches by using, for example, a link layer discovery protocol (LLDP), information such as connection information of each port, for example, each port is connected to which port of which network switch, IP addresses assigned to these ports, and routing tables stored by the network switches, and registers and manages these pieces of collected information in the network configuration information table group 38.

The network path estimation unit 32 is a functional unit having a function of, based on the information stored in the node-side network performance information table 36, the network-side network performance information table 37, and the network configuration information table group 38, respectively estimating communication paths through which TCP communications executed via the in-cluster network 14 pass, and of specifying the estimated communication paths as maximum likelihood paths of the respectively corresponding TCP communications.

In practice, for each TCP communication executed via the in-cluster network 14, the network path estimation unit 32 creates the TCP communication path candidate information table 39 in which all communication paths that can be used by the TCP communication are respectively registered as TCP communication path candidates.

The network path estimation unit 32 respectively simulates, for each combination of the TCP communication path candidates of each TCP communication (hereinafter, referred to as a TCP communication path candidate combination), throughput of the ports of the network switches (the switches 11 and the routers 13) when each TCP communication uses corresponding TCP communication path candidates.

The network path estimation unit 32 compares the simulation result with actual throughput of the ports of the network switches stored in the network-side network performance information table 37, thereby estimating a communication path to be actually used by each TCP communication, and specifying the estimated communication path of each TCP communication as a maximum likelihood path.

The path deviation occurrence determination unit 33 is a program having a function of, based on the simulation result of the simulation executed by the network path estimation unit 32, detecting a communication path on which data traffic of the in-cluster network 14 deviates. Specifically, the path deviation occurrence determination unit 33 extracts a bottleneck port, which satisfies a certain condition, from ports that are bottlenecks (hereinafter, referred to as bottleneck ports) as a port of a communication path on which path deviation occurs.

The overload determination unit 34 is a functional unit having a function of, based on the simulation result, detecting a high-load port in which packet discarding at a certain level or higher occurs, from ports on the maximum likelihood paths of the TCP communications.

The in-cluster communication control unit 35 is a functional unit having a function of, based on information of the bottleneck port that satisfies a certain condition and is detected by the path deviation occurrence determination unit 33, and information of the high-load port detected by the overload determination unit 34, increasing or decreasing the number of connections of each TCP communication for a necessary SDS node 10 and of executing control of limiting a band, to prevent deviation of a communication path and occurrence of an overload in the in-cluster network 14. The in-cluster communication control unit 35 registers and manages control content executed at this time as control history information in the in-cluster communication control history information table 40.

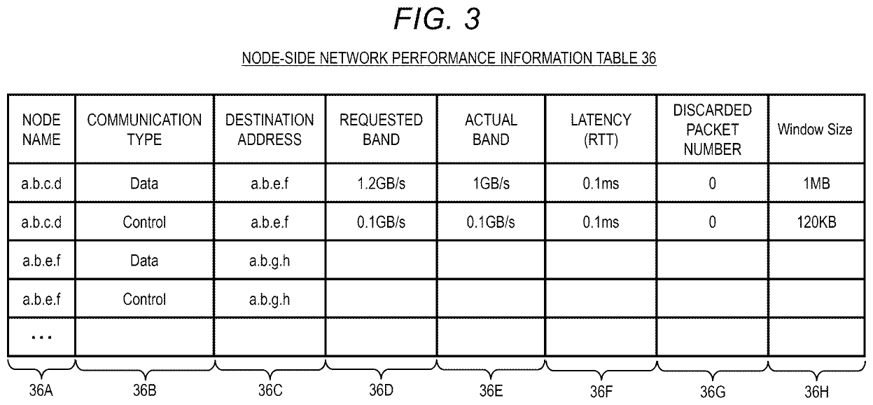

On the other hand, the node-side network performance information table 36 is a table used for managing the performance information of the in-cluster network 14 that is regarding the TCP communications, and the performance information of the in-cluster network 14 is collected by the network performance information management unit 30. As shown in FIG. 3, the node-side network performance information table 36 includes a node name column 36A, a communication type column 36B, a destination address column 36C, a requested band column 36D, an actual band column 36E, a latency column 36F, a discarded packet number column 36G, and a window size column 36H. In the node-side network performance information table 36, one row corresponds to information on one TCP communication executed via the in-cluster network 14 at that time.

The node name column 36A stores an IP address of a port, serving as a communication source of a corresponding TCP communication, in the SDS node 10 of the communication source (transmission source of a packet) of the corresponding TCP communication. The communication type column 36B stores information indicating a type of the TCP communication (for example, “Data” is stored when the TCP communication is a data communication, and “Control” is stored when the corresponding TCP communication is transmission and reception of control information). Further, the destination address column 36C stores an IP address of a communication destination (transmission destination of a packet) of the TCP communication.

The requested band column 36D stores a communication speed requested by the TCP communication (hereinafter, referred to as a requested band). The actual band column 36E stores an actual communication speed of the TCP communication (hereinafter, referred to as an actual band).

The latency column 36F stores latency measured for the corresponding TCP communication (communication delay time). The discarded packet number column 36G stores a total number of packets discarded in the TCP communication. Further, the window size column 36H stores a window size of the TCP communication.

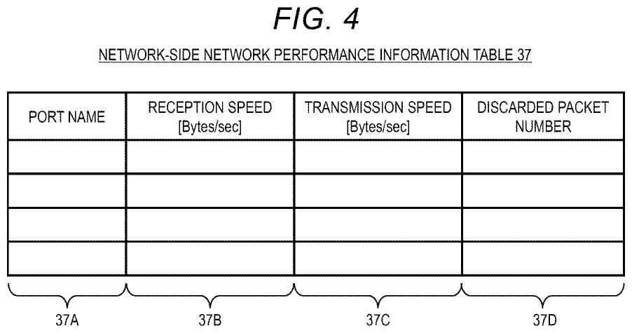

The network-side network performance information table 37 is a table for managing information on network performance at the ports of the network switches (the switches 11 and the routers 13) in the cluster 2, and the information on the network performance is collected by the network performance information management unit 30. As shown in FIG. 4, the network-side network performance information table 37 includes a port name column 37A, a reception speed column 37B, a transmission speed column 37C, and a discarded packet number column 37D. In the network-side network performance information table 37, one row represents measured values for one corresponding port of a corresponding network switch.

The port name column 37A stores an IP address of a corresponding port of a corresponding network switch. Further, the reception speed column 37B stores a reception speed of a packet at the port at a time point at which the information is obtained. The transmission speed column 37C stores a transmission speed of a packet at the port at the time point at which the information is obtained. Further, the discarded packet number column 37D stores the number of packets discarded at the port for a TCP communication executed via the port.

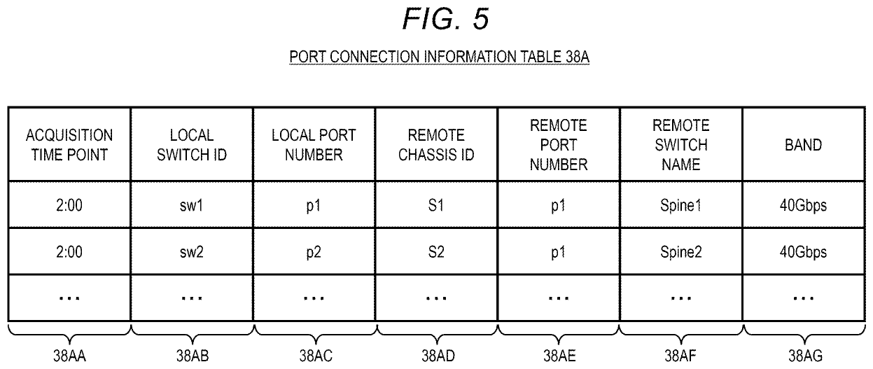

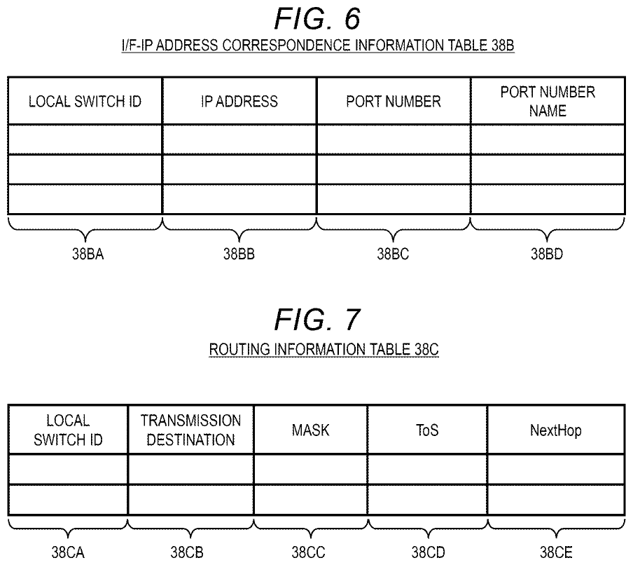

On the other hand, the network configuration information table group 38 includes three tables: a port connection information table 38A shown in FIG. 5, an interface-IP address correspondence information table 38B shown in FIG. 6, and a routing information table 38C shown in FIG. 7.

The port connection information table 38A is a table used for managing a connection relationship between a port of each network switch (the switch 11 and the router 13) in the in-cluster network 14 and a port of another network switch or the SDS node 10. As shown in FIG. 5, the port connection information table 38A includes an acquisition time point column 38AA, a local switch ID column 38AB, a local port number column 38AC, a remote chassis ID column 38AD, a remote port number column 38AE, a remote switch name column 38AF, and a band column 38AG. In the port connection information table 38A, one row corresponds to one connection relationship between network switches.

The acquisition time point column 38AA stores a time point at which information on a corresponding connection relationship is obtained. Further, the local switch ID column 38AB stores an identifier (switch ID) that is assigned to one (local side) network switch in the corresponding connection relationship and is unique to the one network switch. The local port number column 38AC stores a physical port number assigned to one port of the network switch.

The remote switch name column 38AF stores a name of the other (remote side) network switch or another SDS node 10 in the connection relationship. Further, the remote port number column 38AE stores a physical port number of a port, which is connected to a port whose port number is stored in the local port number column 38AC, of the network switch or the SDS node 10. The remote chassis ID column 38AD stores a logical identifier (chassis ID) assigned to the port.

The band column 38AG stores a maximum band of a path that connects a local-side port whose port number is stored in the local port number column 38AC to a remote-side port whose port number is stored in the remote port number column 38AE.

The interface-IP address correspondence information table 38B is a table used for managing port numbers, IP addresses, and the like of the ports of the network switches in the in-cluster network 14. As shown in FIG. 6, the interface-IP address correspondence information table 38B includes a local switch ID column 38BA, an IP address column 38BB, a port number column 38BC, and a port number name column 38BD. In the interface-IP address correspondence information table 38B, one row corresponds to one port of one network switch.

The port number column 38BC stores a port number assigned to a corresponding port. The local switch ID column 38BA stores an identifier (switch ID) of a network switch including the port. Further, the IP address column 38BB stores an IP address assigned to the port. The port number name column 38BD stores a name of the port.

The routing information table 38C is a table used for managing information of routing tables respectively obtained from the network switches. As shown in FIG. 7, the routing information table 38C includes a local switch ID column 38CA, a transmission destination column 38CB, a mask column 38CC, a ToS column 38CD, and a NextHop column 38CE. In the routing information table 38C, one row corresponds to one piece of routing information registered in a routing table obtained from the switch 11 or the router 13.

The local switch ID column 38CA stores an identifier (switch ID) of a network switch that obtains the routing information. The transmission destination column 38CB stores an IP address that may be specified as a transmission destination of a communication packet. Further, the mask column 38CC stores a value of a net mask. The ToS column 38CD stores type of service (ToS) information such as a priority order of transfer of a communication packet that matches a transmission destination and a condition of a mask. Further, the NextHop column 38CE stores an IP address of a port of a next-stage network switch to be a transmission destination of a packet that matches the transmission destination and the condition of the net mask.

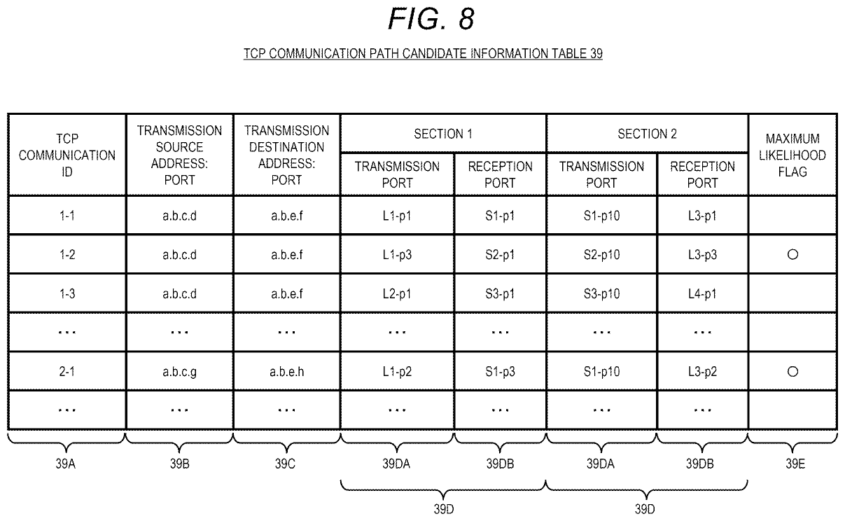

The TCP communication path candidate information table 39 is a table used for managing TCP communication path candidates of the TCP communications executed via the in-cluster network 14, and the TCP communication path candidates are extracted by the network path estimation unit 32. As shown in FIG. 8, the TCP communication path candidate information table 39 includes a TCP communication ID column 39A, a transmission source address column 39B, a transmission destination address column 39C, a plurality of section columns 39D, and a maximum likelihood flag column 39E. In the TCP communication path candidate information table 39, one row corresponds to one TCP communication path candidate for one TCP communication.

The TCP communication ID column 39A stores an identifier (TCP communication ID) obtained by adding a unique branch number to a TCP communication path candidate corresponding to an identifier that is assigned to a corresponding TCP communication and that is unique to the TCP communication. The transmission source address column 39B stores an IP address assigned to a transmission source port of the SDS node 10 in a transmission source of a packet in the TCP communication path candidate. The transmission destination address column 39C stores an IP address assigned to a transmission destination port of the SDS node 10 in a transmission destination in the TCP communication path candidate.

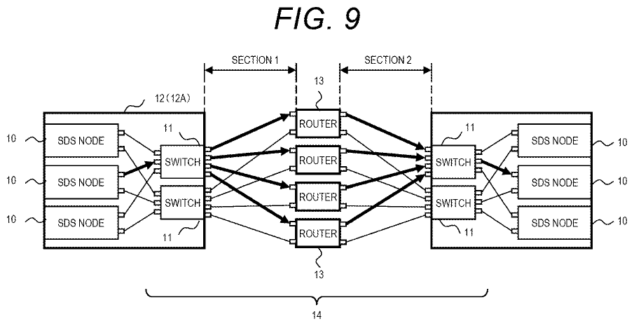

As shown in FIG. 9, the section columns 39D are provided respectively corresponding to sections, with a section starting from a network switch (the switch 11 or the router 13) of the in-cluster network 14 to a next-stage network switch being set as a section 1.

Each section column 39D is divided into a transmission port column 39DA and a reception port column 39DB. An identifier (port ID) of a corresponding port of a network switch serving as a transmission side of a TCP communication in a corresponding section in a corresponding TCP communication route candidate is stored in the transmission port column 39DA. An identifier (port ID) of a corresponding port of a network switch serving as a reception side of the TCP communication in the TCP communication path candidate is stored in the reception port column 39DB.

For each TCP communication executed via the in-cluster network 14, a flag indicating a maximum likelihood path (hereinafter, referred to as a maximum likelihood flag) is stored in the maximum likelihood flag column 39E corresponding to a TCP communication path candidate having a highest possibility of being actually used in the TCP communication (maximum likelihood path).

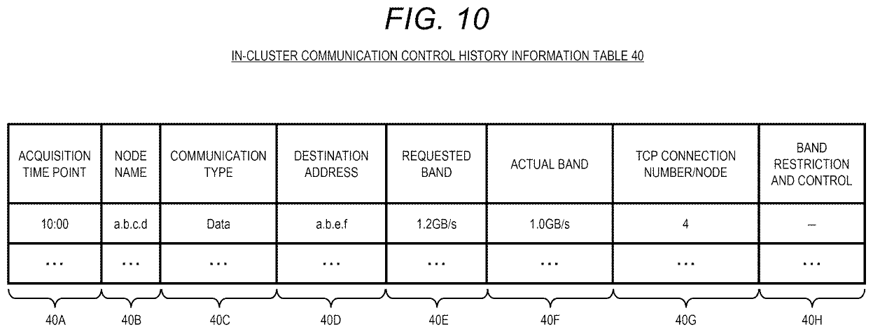

The in-cluster communication control history information table 40 is a table used for managing control content for the SDS nodes 10 such as (i) increasing or decreasing the number of connections or (ii) a band limitation executed by the in-cluster communication control unit 35 (FIG. 1) in the past, to prevent occurrence of a bottleneck port or an overload port in the in-cluster network 14. As shown in FIG. 10, the in-cluster communication control history information table 40 includes an acquisition time point column 40A, anode name column 40B, a communication type column 40C, a destination address column 40D, a requested band column 40E, an actual band column 40F, a TCP connection number/node column 40G, and a band restriction and control column 40H. In the in-cluster communication control history information table 40, one row corresponds to control executed on one SDS node 10.

The node name column 40B, the communication type column 40C, the destination address column 40D, the requested band column 40E, and the actual band column 40F store the same information as the information stored in the corresponding node name column 36A, the corresponding communication type column 36B, the corresponding destination address column 36C, the corresponding requested band column 36D, and the corresponding actual band column 36E in the node-side network performance information table 36 described above with reference to FIG. 3, respectively. The acquisition time point column 40A stores time points at which these pieces of information are obtained.

The TCP connection number/node column 40G stores the number of TCP connections (multiplicity) in a corresponding TCP communication. The band restriction and control column 40H stores information indicating whether band restriction and control is executed for the TCP communication (for example, “◯” is used when the band restriction and control is executed, and “-” is used when the band restriction and control is not executed).

### (3) Various Processings Related to Network Management Function

Next, specific processing content of various processings executed in the network management server 3 in association with the network management function will be described. Hereinafter, although processing entities of the various processings will be described as the functional units (the network performance information management unit 30, the network configuration information management unit 31, the network path estimation unit 32, the path deviation occurrence determination unit 33, the overload determination unit 34 or the in-cluster communication control unit 35) described above with reference to FIG. 2, in practice, it is needless to say that the CPU 20 (FIG. 1) of the network management server 3 executes the processings based on the management program 25 loaded from the storage device 23 (FIG. 1) into the memory (FIG. 1).

### (3-1) Network Information Acquisition Processing

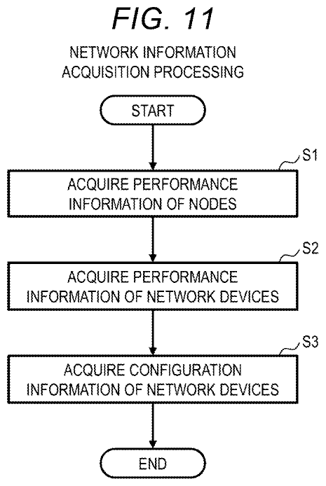

FIG. 11 shows a processing procedure of a network information acquisition processing executed by the network management server 3 to acquire the information on the performance and configuration of the in-cluster network 14.

The network information acquisition processing is periodically started. First, the network performance information management unit 30 (FIG. 2) obtains, from each SDS node 10 in the cluster 2, information such as a requested band, an actual band, latency, the number of discarded packets, and a window size of a TCP communication executed by the SDS node 10, and stores these pieces of obtained performance information in the node-side network performance information table 36 (FIG. 3) (S1).

The network performance information management unit 30 obtains, from each network switch (the switch 11 and the router 13) that constitutes the in-cluster network 14, information such as the current number of transmitted or received packets and the current number of discarded packets per unit time at each port of the network switch, and stores these pieces of obtained performance information in the network-side network performance information table 37 (FIG. 4) (S2).

Next, the network configuration information management unit 31 (FIG. 2) obtains, from each network switch that constitutes the in-cluster network 14, information on a connection destination of each port of the network switch, on a communication band allowed for a corresponding communication path, and the like, and information on a network configuration such as a routing table stored in the network switch, and stores these pieces of obtained information respectively in corresponding tables of the network configuration information table group 38 (the port connection information table 38A, the interface-IP address correspondence information table 38B, and the routing information table 38C) (S3). Thereby, the network path information acquisition processing ends.

### (3-2) Network Management Processing

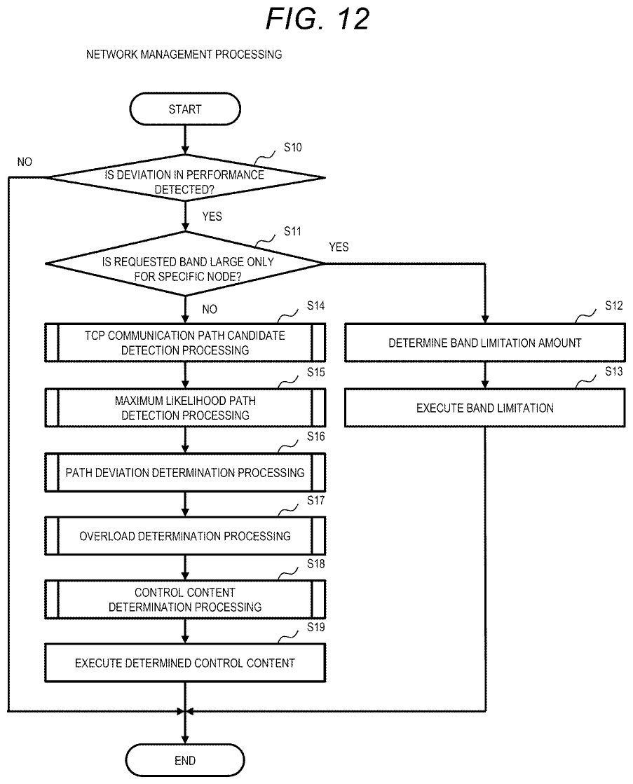

FIG. 12 shows a processing procedure of a network management processing executed by the network management server 3 after the processing of FIG. 11 ends. The network management server 3 controls the number of TCP connections and the band in the TCP communication between the SDS nodes 10 via the in-cluster network 14 in accordance with the processing procedure shown in FIG. 11.

In practice, when the network management processing is started, first, the network path estimation unit 32 (FIG. 2) compares actual bands of respective SDS nodes 10 stored in the node-side network performance information table 36, and determines whether there is an SDS node 10 having lower communication performance (actual band) as compared with communication performance of other SDS nodes 10 (S10). When a negative result is obtained in the determination, the network path estimation unit 32 ends the processing. Accordingly, this network management processing ends.

On the contrary, when a positive result is obtained in the determination of step S10, the network path estimation unit 32 compares currently obtained requested bands of the respective SDS nodes 10 stored in the node-side network performance information table 36, and determines whether a band (requested band) requested by the SDS node 10 having lower communication performance as compared with other SDS nodes 10 is larger than requested bands of other SDS nodes 10 (S11).

Obtaining a positive result in the determination means that a communication load is concentrated on the SDS node 10 having the low communication performance. Thus, at this time, the network path estimation unit 32 notifies the in-cluster communication control unit 35 (FIG. 2) of this fact.

Upon receiving such a notification, the in-cluster communication control unit 35 determines a (band) limitation amount of a communication band to limit the communication band to be used by the SDS node 10 having the low communication performance (S12). Limiting the communication band to be used by the SDS node 10 having the low communication performance as described above is because, when a load of an SDS node 10 in a communication source (transmission source of a packet) of a TCP communication is larger than a load of an SDS node 10 in a communication destination (transmission destination of a packet), TCP-Incast due to buffer overrun of the switch 11 may occur, and the limiting of the communication band is to prevent such TCP-Incast.

Next, the in-cluster communication control unit 35 notifies the SDS node 10 of the limitation amount determined in step S12 (S13). Thus, the SDS node 10 that has received the notification restricts the band of the TCP communication such that the band of the TCP communication executed at that time falls within a notified band. Thereafter, the in-cluster communication control unit 35 ends the processing. Accordingly, the current network management processing ends.

On the contrary, obtaining a negative result in the determination of step S11 means that the entire in-cluster network is in an overload state, so that throughput of the entire in-cluster network 14 is reduced. Thus, at this time, in the network management server 3, the following processings of steps S14 to S19 are executed to increase or decrease connections of a TCP communication for a necessary SDS node 10 or to control a band limitation.

Specifically, first, the network path estimation unit 32 calculates all TCP communication path candidates for each TCP communication executed via the in-cluster network 14 at that time, and stores the calculated information of the TCP communication path candidates in the TCP communication path candidate information table 39 (FIG. 8) (S14).

Next, the network path estimation unit 32 extracts, from all combinations of the TCP communication path candidates of each TCP communication (hereinafter, these combinations are referred to as TCP communication path candidate combinations, respectively), one TCP communication path candidate combination through which data traffic of the TCP communication is estimated to actually pass, and specifies TCP communication path candidates that constitute the TCP communication path candidate combination as maximum likelihood paths of the corresponding TCP communication (S15).

Specifically, for all the TCP communication path candidate combinations, the network path estimation unit 32 respectively calculates, by simulation, assumed values of a transmission speed and a reception speed of each port of each network switch (the switch 11 and the router 13) when the data traffic of the TCP communications passes through the corresponding TCP communication path candidates that constitute the TCP communication path candidate combination. Further, the network path estimation unit 32 respectively compares these calculation results with transmission speeds and reception speeds of respective ports of respective network switches actually measured and stored in the network-side network performance information table 37 (FIG. 4), and specifies TCP communication path candidates that constitute a TCP communication path candidate combination having a smallest sum of differences of these speeds as maximum likelihood paths of the corresponding TCP communication.

Next, the path deviation occurrence determination unit 33 (FIG. 2) determines, based on the simulation results of the maximum likelihood paths, whether there is a port that is a bottleneck (bottleneck port) among the ports of the network switches that constitute the in-cluster network 14 (S16). Thereafter, the overload determination unit 34 (FIG. 2) determines, based on the simulation results of the maximum likelihood paths, whether any port of any network switch is overloaded (S17).

Thereafter, the in-cluster communication control unit 35 executes, based on the determination result of the path deviation occurrence determination unit 33 and the determination result of the overload determination unit 34, a control content determination processing of determining control content (increasing or decreasing of the number of TCP connections or a band limitation of a TCP connection) for the SDS nodes 10 mounted on the active-side SDS racks 12A (FIG. 1) (hereinafter, these SDS nodes 10 are simply referred to as active-side SDS nodes 10) that execute the TCP communications at that time (S18).

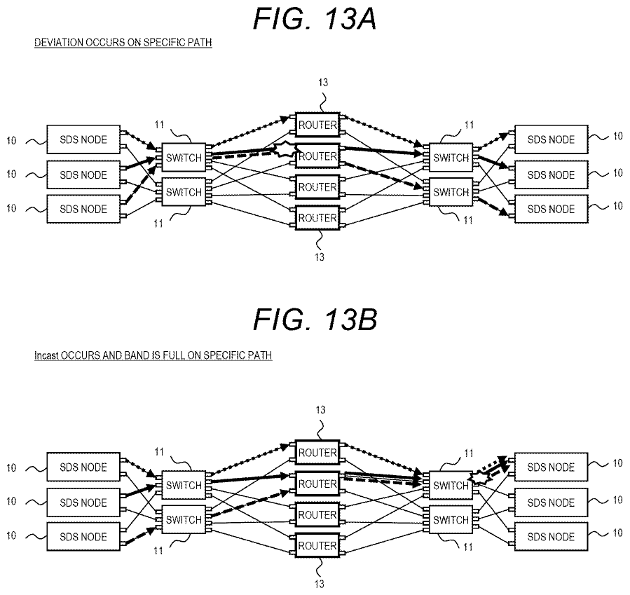

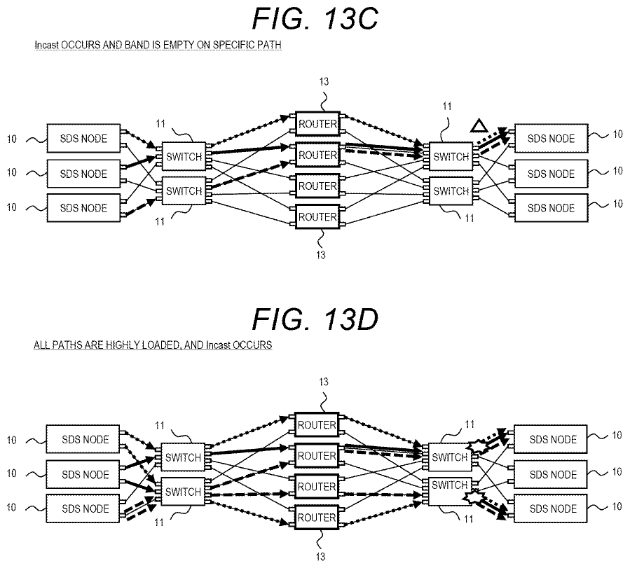

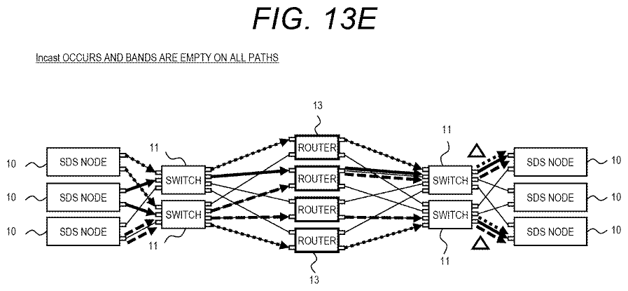

For example, when data traffic deviation occurs, for example, only on a specific path as shown in FIG. 13A, and more specifically, when data traffic of TCP communications having different destinations has a common bottleneck port and a bottleneck only occurs at some ports in which a load can be distributed, the in-cluster communication control unit 35 determines, as control content, to increase the number of TCP connections of these TCP communications (increasing multiplicity).

For example, as shown in FIG. 13B, when data traffic deviation of TCP communications occurs on a path on which a load cannot be distributed, a band of this part of path is used to the maximum, and a packet is discarded only at a specific port of this part of path, the in-cluster communication control unit 35 determines, as control content, to increase the number of TCP connections of the TCP communications by establishing a connection on an alternative path (increasing multiplicity).

For example, as shown in FIG. 13C, when data traffic deviation of TCP communications occurs in a path on which a load cannot be distributed, a band of this part of path is empty, but a packet is discarded only at a specific port of this part of path, the in-cluster communication control unit 35 determines, as control content, to reduce the number of TCP connections of these TCP communications (decreasing multiplicity) and to limit bands of these TCP communications as necessary.

For example, as shown in FIG. 13D, when data traffic of TCP communications having different destinations does not have a common bottleneck port, a path such as a path on which a load can be distributed also exceeds a maximum band, and a packet is discarded, the in-cluster communication control unit 35 determines, as control content, to limit bands of all the TCP communications.

For example, as shown in FIG. 13E, when data traffic of TCP communications having different destinations does not have a common bottleneck port, a path such as a path on which a load can be distributed also does not exceed a maximum band, but a packet is discarded, the in-cluster communication control unit 35 determines, as control content, to reduce the number of TCP connections of these TCP communications (decreasing multiplicity).

Thereafter, the in-cluster communication control unit 35 gives an instruction, to a necessary SDS node 10, to increase or decrease the number of TCP connections or to limit a band of a TCP connection in accordance with a determination result of step S18 (S19). Further, when the processing of step S19 ends, the network management processing ends.

### (3-3) TCP Communication Path Candidate Detection Processing

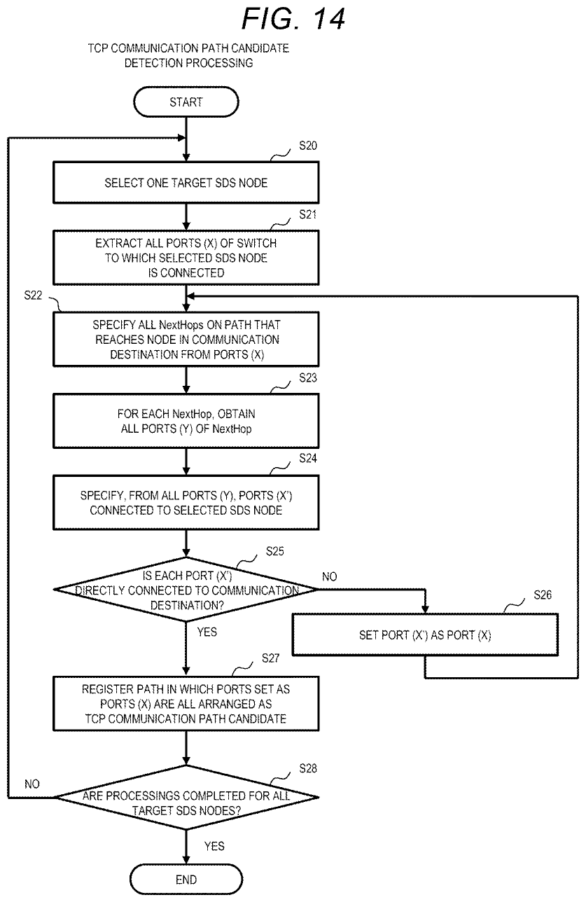

FIG. 14 shows a processing procedure of a TCP communication path candidate detection processing executed by the network path estimation unit 32 in step S14 of the network management processing described above with reference to FIG. 12. In accordance with the processing procedure shown in FIG. 14, the network path estimation unit 32 detects all TCP communication path candidates for each TCP communication executed via the in-cluster network 14 at that time.

In practice, when the network management processing proceeds to step S14, the network path estimation unit 32 starts the processing procedure shown in FIG. 14, and first, selects one SDS node (hereinafter, referred to as a target SDS node) 10 that performs a TCP communication at that time from the SDS nodes 10 in the cluster (S20).

Next, the network path estimation unit 32 refers to the port connection information table 38A (FIG. 5), and extracts all ports (X) of a network switch (here, the switch 11) to which the SDS node 10 selected in step S20 (hereinafter, referred to as a selected SDS node) is connected (S21).

Next, the network path estimation unit 32 refers to the routing information table 38C (FIG. 7), and specifies all NextHops that respectively reach an SDS node 10 in a communication destination from the ports (X) extracted in step S21 (S22).

Thereafter, the network path estimation unit 32 refers to the interface-IP address correspondence information table 38B (FIG. 6), and obtains, for each NextHop specified in step S22, port numbers and IP addresses of all ports (Y) provided in the NextHop (S23). Further, the network path estimation unit 32 specifies, from the ports (Y) for which the port numbers and the like are obtained in step S23, all ports (X′) connected to the selected SDS node 10 (S24).

The network path estimation unit 32 refers to the port connection information table 38A, and determines, for each port (X′), whether each port (X′) specified in step S24 is directly connected to the SDS node 10 in the communication destination without passing through another NextHop (S25).

When there is a port (X′) for which a negative result is obtained in the determination, the network path estimation unit 32 sets the port (X′) as a port (X) (S26), then returns to step S22, and thereafter, repeats processings of steps S22 to S25 until a positive result is obtained for all the ports (X′) in step S25.

Then, when a positive result is eventually obtained for all the ports (X′) in step S25, the network path estimation unit 32 sets, for each of the ports (X′) for which the positive result has already been obtained in step S25, a path in which ports set as the ports (X) before reaching the ports (X′)are arranged in order, as the TCP communication path candidate of a TCP communication executed by the selected SDS node 10 and registers necessary information in the TCP communication path candidate information table 39 (S27).

Next, the network path estimation unit 32 determines whether the processings of step S21 and subsequent steps have been executed for all target SDS nodes 10 (S28). When a negative result is obtained in the determination, the network path estimation unit 32 returns to step S20, and then repeats the processings of steps S20 to S28 while sequentially switching the SDS node 10 selected in step S20 to another target SDS node 10 that has not yet been processed in step S21 and subsequent steps.

Further, when a positive result is eventually obtained in step S28 by completing the detection of the TCP communication path candidates for all the target SDS nodes 10, the network path estimation unit 32 ends the TCP communication path candidate detection processing.

### (3-4) Maximum Likelihood Path Detection Processing

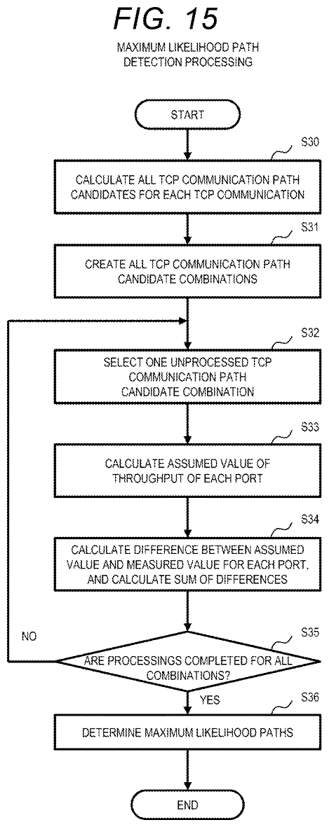

FIG. 15 shows specific processing content of a maximum likelihood path detection processing executed by the network path estimation unit 32 in step S15 of the network management processing described above with reference to FIG. 12. In accordance with a processing procedure shown in FIG. 15, the network path estimation unit 32 detects the maximum likelihood paths of the TCP communications executed via the in-cluster network 14 at that time.

In practice, when a series of processings described above with reference to FIG. 12 proceed to step S15, the network path estimation unit 32 starts the maximum likelihood path detection processing shown in FIG. 15. First, the network path estimation unit 32 refers to the node-side network performance information table 36 (FIG. 3), and for each TCP communication executed via the in-cluster network at that time, calculates, based on network performance information of all SDS nodes 10 in the cluster 2, all communication paths that can be used by the TCP communication as TCP communication path candidates of the TCP communication (S20).

Next, the network path estimation unit 32 creates all TCP communication path candidate combinations in which the TCP communication path candidates of each TCP communication are combined one by one (S21), and selects one TCP communication path candidate combination that has not yet been processed in step S33 and subsequent steps from the created TCP communication path candidate combinations (S32).

Next, the network path estimation unit 32 calculates assumed values of throughput of each port of each network switch by a simulation assuming that data traffic of an amount of an actual band of a corresponding TCP communication passes through the TCP communication path candidates that constitute the TCP communication path candidate combination selected in step S32 (hereinafter, referred to as a selected TCP communication path candidate combination) (S33).

The network path estimation unit 32 calculates, for each port of each network switch, a difference between (i) a value of throughput actually measured at each port and stored in the network-side network performance information table 37 (FIG. 4) and (ii) the assumed value of throughput of each port calculated in step S33, and calculates a sum of calculated differences as a sum of differences of the selected TCP communication path candidate combination (S34).

Next, the network path estimation unit 32 determines whether the processings of steps S33 and S34 have been executed for all TCP communication path candidate combinations (S35). When a negative result is obtained in the determination, the network path estimation unit 32 returns to step S32, and then repeats the processings of steps S32 to S35 while sequentially switching the TCP communication path candidate combination selected in step S32 to another TCP communication path candidate combination that has not yet been processed in step S33 and subsequent steps.

When a positive result is eventually obtained in step S35 by completing execution of the processings of steps S33 and S34 for all the TCP communication path candidate combinations, the network path estimation unit 32 determines TCP communication path candidates, which constitute a TCP communication path candidate combination having a smallest value of the sum of differences calculated as described above, as maximum likelihood paths of a corresponding TCP communication (S36). Thereafter, the network path estimation unit 32 ends the maximum likelihood path detection processing.

### (3-5) Path Deviation Occurrence Determination Processing

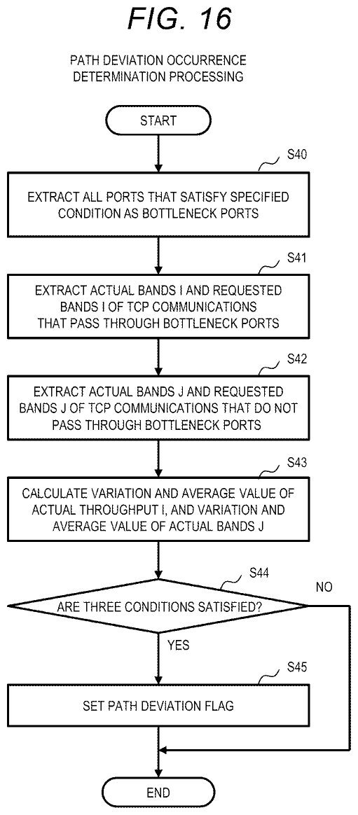

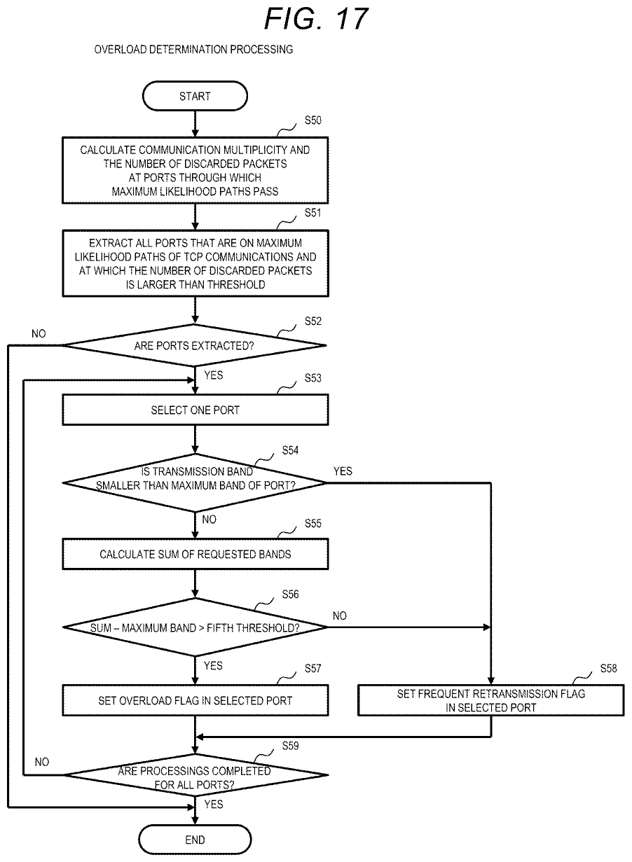

FIG. 16 shows specific processing content of a path deviation occurrence determination processing executed by the path deviation occurrence determination unit 33 in step S16 of the network management processing described above with reference to FIG. 12. In accordance with a processing procedure shown in FIG. 16, the path deviation occurrence determination unit 33 determines whether deviation occurs in communication paths of the TCP communications executed via the in-cluster network 14 at that time.

In practice, when a series of processings described above with reference to FIG. 12 proceed to step S16, the path deviation occurrence determination unit 33 starts the path deviation occurrence determination processing shown in FIG. 16. The path deviation occurrence determination unit 33 first extracts all bottleneck ports from the ports of the network switches (the switches 11 and the routers 13) (S40).

Specifically, for each port of each network switch, the path deviation occurrence determination unit 33 obtains a maximum band of a communication path to which the port is connected from the port connection information table 38A (FIG. 5), obtains actual throughput of the port (hereinafter, referred to as an actual band) from the network-side network performance information table 37 (FIG. 4), and extracts all ports whose maximum bands and actual bands satisfy the following relationship as the bottleneck ports.

maximum band of port—throughput value<first threshold (1)

In Relationship (1), the “first threshold” is a small value that is close to 0 and set in advance.

Next, the path deviation occurrence determination unit 33 extracts all TCP communications in which the maximum likelihood paths estimated by the network path estimation unit 32 pass through any of the bottleneck ports extracted in step S40, and extracts actual bands (I) and requested bands (I) of TCP connections of these TCP communications from the node-side network performance information table 36 (FIG. 3) (S41).

The path deviation occurrence determination unit 33 extracts, from the node-side network performance information table 36, actual bands (J) and requested bands (J) of TCP connections of TCP communications in which the maximum likelihood paths estimated by the network path estimation unit 32 do not pass through any of the bottleneck ports extracted in step S40 (S42).

Thereafter, the path deviation occurrence determination unit 33 classifies all the current TCP communications executed via the in-cluster network 14 into (i) a group of TCP communications that pass through any of the bottleneck ports detected in step S40 and (ii) a group of TCP communications that do not pass through these bottleneck ports. For each group, the path deviation occurrence determination unit 33 calculates deviation and an average value of actual bands (I or J) of TCP communications in the group (S43).

Next, the path deviation occurrence determination unit 33 determines whether the deviation and the average value of the actual bands (I or J) for each group calculated in step S43 satisfy all the following three conditions (A) to (C) (S34).

(A) Both the deviation of the actual bands (I) and the deviation of the actual bands (J) are within a second threshold set in advance.

(B) An average value (I) of the actual bands (I) satisfies the following Relationship.

average value (I)×the number of TCP communications−throughput value of port<second threshold (2)

In Relationship (2), the “second threshold” is a fixed value set in advance.

(C) An average value (J) of the requested bands satisfies the following Relationship.

average value (J)−average value (I)>third threshold (3)

In Relationship (3), the “third threshold” is a fixed value set in advance.

When a negative result is obtained in the determination, the path deviation occurrence determination unit 33 determines that there is no deviation in the communication paths of the TCP communications executed via the in-cluster network 14 at that time, and ends the path deviation occurrence determination processing.

On the contrary, when a positive result is obtained in the determination in step S44, the path deviation occurrence determination unit 33 sets a path deviation flag in the bottleneck port extracted in step S30 on maximum likelihood paths of a corresponding TCP communication (S45), and then ends the path deviation occurrence determination processing.

### (3-6) Overload Determination Processing

FIG. 17 shows specific processing content of an overload determination processing executed by the overload determination unit 34 in step S17 of the network management processing described above with reference to FIG. 12. In accordance with a processing procedure shown in FIG. 17, the overload determination unit 34 determines whether a part or all of the in-cluster network 14 is in an overload state at that time.

In practice, when a series of processings described above with reference to FIG. 12 proceed to step S17, the overload determination unit 34 starts the overload determination processing shown in FIG. 17. First, the overload determination unit 34 specifies, by referring to the TCP communication path candidate information table (FIG. 8), ports of network switches (the switches 11 and the routers 13) through which the maximum likelihood paths of the TCP communications specified by the network path estimation unit 32 pass, and separately calculates communication multiplicity (the number of PCT sections that pass through the port) of these specified ports and the number of discarded packets at the ports (S50).

Next, the overload determination unit 34 refers to the node-side network performance information table 36 (FIG. 3), and extracts all ports that are on maximum likelihood paths of any of the TCP communications and whose number of discarded packets is larger than a threshold (S51). Specifically, the overload determination unit 34 extracts ports that are on the maximum likelihood paths of any of the TCP communications and whose number of discarded packets is larger than a fourth threshold set in advance.

Thereafter, the overload determination unit 34 determines whether at least one port has been extracted in step S51 (S52).

When a negative result is obtained in the determination, it means that in the in-cluster network 14, there is no network switch that causes buffer overflow at a certain level or higher due to an overload. Thus, at this time, the overload determination unit 34 ends the overload determination processing.

On the contrary, obtaining a positive result in the determination of step S52 means that in the in-cluster network 14, there is the network switch that causes the buffer overflow at a certain level or higher due to the overload. Thus, at this time, the overload determination unit 34 selects one port from the ports extracted in step S51 (S53).

The overload determination unit 34 refers to the node-side network performance information table 36 (FIG. 3) and the port connection information table 38A (FIG. 5), and determines whether an actual transmission band of the port selected in step S53 (hereinafter, referred to as a selected port) is smaller than a maximum band of the port (S54).

When a negative result is obtained in the determination, it is considered that the selected port is in an overload state. Thus, at this time, the overload determination unit 34 calculates a sum of requested bands of all TCP communications that pass through the selected port (S55), and determines whether the calculated sum satisfies the following Relationship (S56).

sum of requested bands−maximum band of selected port>fifth threshold (4)

In Relationship (4), the “fifth threshold” is a small value close to 0.

Obtaining a positive result in the determination means that the requested bands are too large with respect to the maximum band of the selected port, so that it can be assumed that an overload state constantly occurs. Thus, at this time, the overload determination unit 34 separately sets, in the TCP communication path candidate information table 39 (FIG. 8), an overload flag in the transmission port columns 39DA (FIG. 8) and the reception port columns 39DB (FIG. 8) that are corresponding to selected ports in each row corresponding to the maximum likelihood paths of the TCP communications that pass through the selected ports (S57). The overload flag is a flag indicating that a corresponding port is in a constant overload state.

On the contrary, obtaining a negative result in the determination of step S56 means that the requested bands are slightly more than the maximum band of the selected port, so that it can be assumed that retransmission of a packet to the selected port due to packet discarding occurs frequently. Thus, at this time, the overload determination unit 34 separately sets, in the TCP communication path candidate information table 39, a frequent retransmission flag in the transmission port columns 39DA and the reception port columns 39DB that are corresponding to the selected ports in each row corresponding to the maximum likelihood paths of the TCP communications that pass through the selected ports (S58). The frequent retransmission flag is a flag indicating that retransmission to a corresponding port occurs frequently.

On the other hand, when a positive result is obtained in the determination of step S54, although the number of discarded packets in the selected port is large, a band that can be used remains in the selected port. Thus, it can be considered that an overload only occurs instantaneously. Thus, at this time, the overload determination unit 34 separately sets the frequent retransmission flag in the transmission port columns 39DA and the reception port columns 39DB that are corresponding to the selected ports in each row corresponding to the maximum likelihood paths of the TCP communications that pass through the selected ports (S58). Thereafter, the overload determination unit 34 ends the overload determination processing.

Thereafter, the overload determination unit 34 determines whether the processings of step S54 and subsequent steps have been executed for all ports extracted in step S52. When a negative result is obtained in the determination, the overload determination unit 34 returns to step S53, and then repeats the processings of steps S53 to S59 while sequentially switching the port selected in step S53 to another port that has not yet been processed in step S54 and subsequent steps among the ports extracted in step S52.

When a positive result is eventually obtained in step S59 by finishing setting the overload flag or the frequent retransmission flag for all the ports extracted in step S52, the overload determination unit 34 ends the overload determination processing.

### (3-7) Control Content Determination Processing

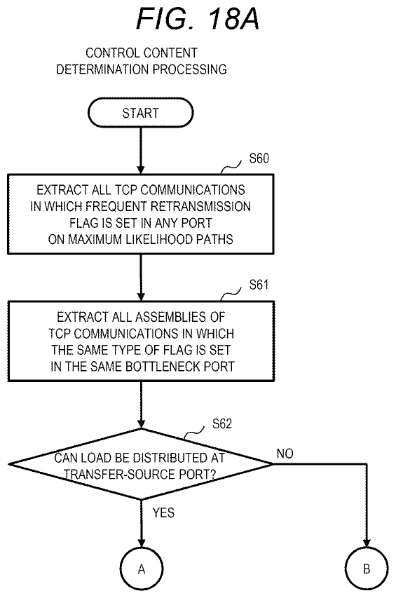

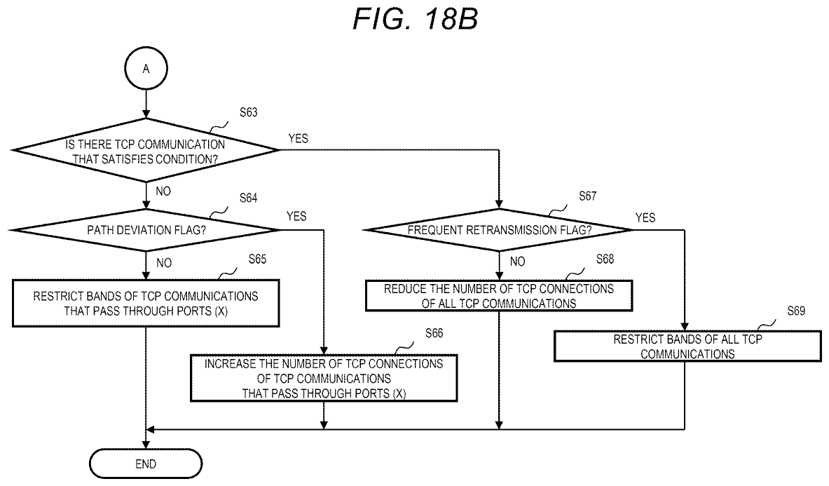

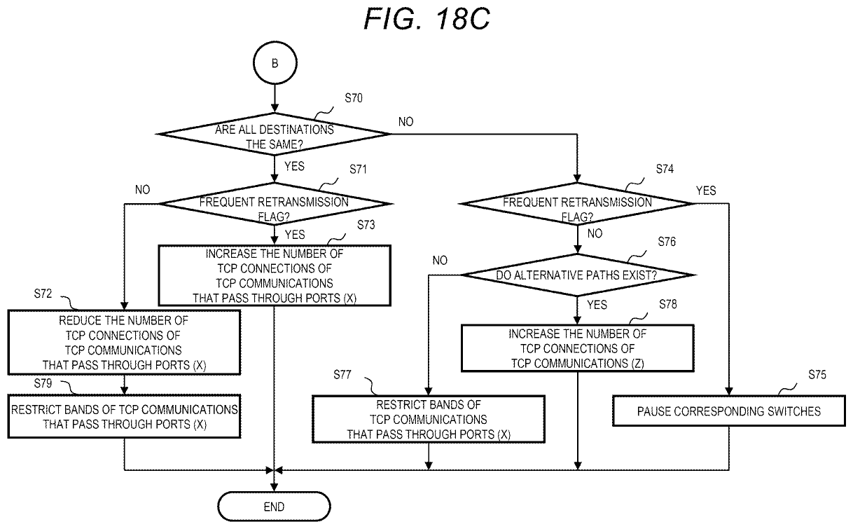

FIGS. 18A to 18C show specific processing content of a control content determination processing executed by the in-cluster communication control unit 35 in step S18 of the network management processing described above with reference to FIG. 12. In accordance with a processing procedure shown in FIGS. 18A to 18C, the in-cluster communication control unit 35 determines control content to be executed for the SDS nodes 10 mounted on the active-side SDS racks 12A.

In practice, when a series of processings described above with reference to FIG. 12 proceed to step S18, the in-cluster communication control unit 35 starts the control content determination processing shown in FIGS. 18A to 18C. First, the in-cluster communication control unit 35 extracts, from the maximum likelihood paths of each TCP communication detected in step S15 of FIG. 12, all TCP communications in which the frequent retransmission flag is set for ports of any network switch on the maximum likelihood paths (S60).

Next, the in-cluster communication control unit 35 extracts, from the TCP communications extracted in step S60, all assemblies of the TCP communications in which the “same type of flag” (the frequent retransmission flag or the overload flag) is set at the same bottleneck port (X) (S61).

Next, for each of the assemblies of the TCP communications extracted in step S61, the in-cluster communication control unit 35 determines whether a port of a transfer source, which is connected to the bottleneck port (X) and through which a packet is transferred to the bottleneck port (X) (hereinafter, referred to as a transfer-source port), is a port other than the bottleneck port (X) at which a load can be distributed (that is, whether the transfer-source port is connected to a port (X′) other than the bottleneck port (X), and whether the transfer-source port is a port through which a packet can be transmitted to a destination of the transfer-source port via the port (X′)) (S62).

When a positive result that there are assemblies of the TCP communications is obtained in the determination, the in-cluster communication control unit 35 determines whether all the ports (X′) exist on the maximum likelihood paths and whether there is a TCP communication (Z′) in which the same type of flag with that of the bottleneck port (X) (the frequent retransmission flag, the overload flag, or the path deviation flag) is set (S63).

When a negative result is obtained in the determination, the in-cluster communication control unit 35 determines whether the “the same type of flag” in step S63 is a path deviation flag (S64).

When a negative result is obtained in the determination, the in-cluster communication control unit 35 determines, as control content, to control the corresponding SDS nodes 10 on an active-side (SDS nodes 10 of communication sources of the TCP communications, the same applies to the following) to restrict bands of TCP communications executed respectively passing the bottleneck ports (X) (S65). Thereafter, the in-cluster communication control unit 35 ends the control content determination processing.

When a positive result is obtained in the determination of step S64, as described above with reference to FIG. 13A, the in-cluster communication control unit 35 determines, as control content, to control the corresponding SDS nodes 10 on the active side to increase the number of TCP connections of the TCP communications executed respectively passing the bottleneck ports (X) (S66). Thereafter, the in-cluster communication control unit 35 ends the control content determination processing.

On the other hand, when a positive result is obtained in the determination of step S63, the in-cluster communication control unit 35 determines whether the “same type of flag” in step S63 is the frequent retransmission flag (S67).

When a negative result is obtained in the determination, as described above with reference to FIG. 13E, the in-cluster communication control unit 35 determines, as control content, to control the SDS nodes 10 on the active side to reduce the number of TCP connections of all TCP communications executed via the in-cluster network 14 (S68). Thereafter, the in-cluster communication control unit 35 ends the control content determination processing.

On the contrary, when a positive result is obtained in the determination of step S67, as described above with reference to FIG. 13D, the in-cluster communication control unit 35 determines, as control content, to control the SDS nodes 10 on the active side to restrict bands of all TCP communications executed via the in-cluster network 14 (S69). Thereafter, the in-cluster communication control unit 35 ends the control content determination processing.

On the other hand, when a negative result that there are assemblies of the TCP communications is obtained in the determination of step S62, the in-cluster communication control unit 35 determines whether all destinations of the TCP communications that constitute the assemblies are the same SDS nodes 10 (S70).

When a positive result is obtained in the determination of step S70, the in-cluster communication control unit 35 determines whether the “same type of flag” in step S61 is the frequent retransmission flag (S71).

When a negative result is obtained in the determination, as described above with reference to FIG. 13C, the in-cluster communication control unit 35 determines, as control content, to reduce the number of TCP connections of TCP communications executed respectively passing the bottleneck ports (X) (S72) and to control the corresponding SDS nodes 10 on the active side to restrict bands of the TCP connections that pass through the bottleneck ports (X) (S79), and ends the control content determination processing.

On the contrary, when a positive result is obtained in the determination of step S71, as described above with reference to FIG. 13B, the in-cluster communication control unit 35 determines, as control content, to control the corresponding SDS nodes 10 on the active side to increase the number of TCP connections of the TCP communications executed respectively passing the bottleneck ports (X) (S73). Thereafter, the in-cluster communication control unit 35 ends the control content determination processing.

When a negative result is obtained in the determination of step S70, the in-cluster communication control unit 35 determines whether the “same type of flag” in step S61 is the frequent retransmission flag (S74).

When a positive result is obtained in the determination, the in-cluster communication control unit 35 determines to temporarily stop movements of a network switch including the bottleneck port (X) (S75), and then ends the control content determination processing.

On the contrary, when a negative result is obtained in the determination of step S74, the in-cluster communication control unit 35 determines whether there is an alternative path for each of the TCP communications that constitute the assemblies of the TCP communications extracted in step S61 (S76).

When a negative result is obtained in the determination, the in-cluster communication control unit 35 determines, as control content, to control the corresponding SDS nodes 10 on the active side to restrict the bands of the TCP communications executed respectively passing the bottleneck ports (X) (S77). Thereafter, the in-cluster communication control unit 35 ends the control content determination processing.

When a positive result is obtained in the determination of step S76, the in-cluster communication control unit 35 determines, as control content, to control the corresponding SDS nodes 10 on the active side to increase the number of TCP connections of the TCP communications executed respectively passing the bottleneck ports (X) (S78). Thereafter, the in-cluster communication control unit 35 ends the control content determination processing.

### (4) Effects of Present Embodiment

As described above, in the storage system 1 in the present embodiment, the network management server 3 separately collects information on the performance and the configuration of the in-cluster network 14 in the cluster 2 from the SDS nodes 10 and the network switches (the switches 11 and the routers 13) in the cluster 2, detects occurrence of the deviation of communication path and the overload based on these collected information, and increases and decreases the number of connections of the necessary TCP communication or limits the communication band to prevent the deviation of communication path and the overload. Therefore, according to the storage system 1, network performance can be collectively managed, and a decrease in the network performance can be prevented while improving use efficiency of the entire network.

### (5) Other Embodiments

Although in the embodiment described above, a case has been described where the present invention is applied to the network management server 3 that manages the in-cluster network 14 configured as in FIG. 1 of the present invention, the present invention is not limited thereto. The present invention can be widely applied to a network management apparatus that manages a network including various other configurations.

In the embodiment described above, as a processing method of the TCP communication path candidate detection processing described above with reference to FIG. 14, a case has been described where a path search problem due to a general Dijkstra algorithm is applied, but the present invention is not limited thereto. That is, various other methods can be widely applied as long as the methods can achieve a purpose of searching all possible communication paths including a load distribution section when a packet is transferred in accordance with a routing table.

The present invention can be widely applied to various network management apparatuses that manage a network.

What is claimed is:

1. A network management apparatus configured to manage a network configured to connect nodes in a distributed storage system including a plurality of nodes, the network management apparatus comprising:
a network information collection unit configured to collect information on performance and a configuration of the network from a network device and the respective nodes that constitute the network;
a path estimation unit configured to estimate, based on the information collected by the network information collection unit, a path in the network for each communication executed between the nodes via the network;
a path deviation occurrence determination unit configured to determine, based on an estimated result of the path of each communication, whether deviation exists in the paths used for communications in the network;
an overload determination unit configured to determine, based on the estimated result of the path of each communication, whether an overload occurs in the network; and
a control unit configured to determine, based on a determination result of the path deviation occurrence determination unit and a determination result of the overload determination unit, control content for a corresponding node, and to control the node in accordance with a determined result.

2. The network management apparatus according to claim 1, wherein
the control unit is configured to, when data traffic of the communications having different destinations has a common bottleneck port and the bottleneck port is a port on the path on which load distribution is possible, determine to increase multiplicity of each communication as control content.

3. The network management apparatus according to claim 1, wherein
the control unit is configured to, when data traffic deviation of the communications occurs on a part of path on which load distribution is not possible, a band of the part of path is maximally used, and a packet is discarded at a specific port of the part of path, determine to increase multiplicity of each communication that passes through the port as control content.

4. The network management apparatus according to claim 1, wherein
the control unit is configured to, when data traffic deviation of the communications occurs on a part of path on which load distribution is not possible, a band of the part of path is empty, but a packet is discarded only at a specific port of the part of path, determines to decrease multiplicity of each communication that passes through the port as control content.

5. The network management apparatus according to claim 1, wherein
the control unit is configured to, when data traffic of the communications having different destinations does not have a common bottleneck port, any of the paths on which load distribution is possible exceeds a maximum band, and a packet is discarded, determine to limit bands of all the communications executed via the network as control content.

6. The network management apparatus according to claim 1, wherein
the control unit is configured to, when data traffic of the communications having different destinations does not have a common bottleneck port, none of the paths on which load distribution is possible exceeds a maximum band, but a packet is discarded, determine to decrease multiplicity of all the communications executed via the network as control content.

7. A network management method to be executed by a network management apparatus that manages a network that connects nodes in a distributed storage system including a plurality of nodes, the network management method comprising:
a first step of collecting information on performance and a configuration of the network from a network device and the respective nodes that constitute the network;
a second step of estimating, based on the collected information, a path in the network for each communication executed between the nodes via the network;
a third step of determining, based on an estimated result of the path of each communication, whether deviation exists in the paths used for communications in the network, and determining whether an overload occurs in the network; and
a fourth step of determining, based on a determination result of whether the deviation exists in the paths and a determination result of whether the overload occurs, control content for the corresponding node, and of controlling the node in accordance with a determined result.

8. The network management method according to claim 7, wherein
when data traffic of the communications having different destinations has a common bottleneck port and the bottleneck port is a port on the path on which load distribution is possible, increasing multiplicity of each communication is determined as control content in the fourth step.

9. The network management method according to claim 7, wherein
when data traffic deviation of the communications occurs on a part of path on which load distribution is not possible, a band of the part of path is maximally used, and a packet is discarded at a specific port of the part of path, increasing multiplicity of each communication that passes through the port is determined as control content in the fourth step.

10. The network management method according to claim 7, wherein
when data traffic deviation of the communications occurs on a part of path on which load distribution is not possible, a band of the part of path is empty, but a packet is discarded only at a specific port of the part of path, decreasing multiplicity of each communication that passes through the port is determined as control content in the fourth step.

11. The network management method according to claim 7, wherein
when data traffic of the communications having different destinations does not have a common bottleneck port, any of the paths on which load distribution is possible exceeds a maximum band, and a packet is discarded, limiting bands of all the communications executed via the network is determined as control content in the fourth step.

12. The network management method according to claim 7, wherein
when data traffic of the communications having different destinations does not have a common bottleneck port, none of the paths on which load distribution is possible exceeds a maximum band, but a packet is discarded, decreasing multiplicity of all the communications executed via the network is determined as control content in the fourth step.
